(19) United States
(12) Patent Application Publication
(10) Pub. No.: US 2026/0011238 A1
(43) Pub. Date: Jan. 8, 2026

(54) ALERT SYSTEM FOR USE IN A LIMITED DECENTRALIZED POINT TO POINT NETWORK ENVIRONMENT

(71) Applicant: Get Buzzed Inc., El Cajon, CA (US)

(72) Inventors: Blake Togerson, El Cajon, CA (US); Marcus Grindstaff, El Cajon, CA (US); Andrew Grindstaff, El Cajon, CA (US)

(21) Appl. No.: 18/764,119

(22) Filed: Jul. 3, 2024

(51) Int. Cl. G08B 23/00

(52) U.S. Cl. CPC G08B 23/00

(57) ABSTRACT

A notification system is provided including a first alert device configured to transmit and receive alerts conforming to a long range, low energy consumption point to point or mesh communication protocol and at least one additional alert device configured to transmit and receive alerts conforming to the protocol. The first alert device is configured to transmit a network creation ping using the protocol, the network creation ping receivable by at least one additional alert device approved to join a decentralized network. At least one additional alert device receiving the network creation ping is configured to pair with the first alert device thereby establishing the decentralized network. The first alert device and each additional alert device in the decentralized network is configured to transmit an alert directly to at least one other alert device in the decentralized network using the protocol.

### BACKGROUND

### I. Field

The present invention relates generally to alert systems, and more specifically to devices configured to communicate effectively and efficiently within a limited group setting.

### II. Background

Alert devices have been available for some time. Devices can be provided that allow the user to alert a central network, including commercially available systems such as the Life Alert® system. In such systems, the user may wear the device or have the device close to his or her body, and in the event of an emergency, such as suffering a fall, the user may press a button and may be connected to a central dispatching system which can offer aid and contact appropriate medical personnel or others who have been designated for the user. Communication may be offered such that the user can speak to the dispatcher, or a simple alert may be provided.

Other systems available include wearable devices such as exercise monitors. Such devices monitor certain vital signs, such as heart rate and body temperature, and may alert the wearer of issues arising, such as by vibrating or playing an audible tone. Additionally, certain software programs are available that can be used with smartphones and/or smart watches where the device senses an event such as falling or not moving for extended periods of time, at which point the device may notify a predetermined contact.

Wearable systems that notify a central dispatch introduce delay in addressing the event of concern. Minutes and seconds can be lost when the dispatcher determines the problem and contacts an appropriate medical entity, and the medical entity travels to the victim. In worst case scenarios, such delay can cause a loss of life. Further complicating the issue is that a person may have lost his or her ability to speak, and the dispatcher may simply not know what the issue is and may dispatch the wrong medical entity. For example, with minimal communication, the dispatcher may contact a wellness check entity when in fact an emergency ambulance was warranted, again resulting in loss of time. Such devices and systems typically do not allow the user/wearer to be in direct communication with persons nearby.

Issues with health/exercise monitors include an inability to assess a wide range of factors. In a typical application, the health/exercise monitor simply provides information to the wearer. Such a device is limited in that the wearer falling down, or suffering an event such as a stroke or gastrointestinal issue, may not be interpreted properly. Further, such devices typically do not provide notifications to third parties such that the incapacitated person can be helped in short order. When a health/exercise monitor, smartwatch, or smartphone employs a sensing program that senses things such as the user falling down or being incapacitated for a period of time, the issue arises that the user may have simply acted in a way that is interpreted as a problematic event, i.e., is a false positive. Further, depending on who is designated as the recipient of the alert indication, in addition to being alerted for a false positive event, that person or entity may not be nearby at the time and may not be in a position to offer aid. Additionally, use of a smartphone or smartwatch allows for the contacted entity to contact the user by smartphone. If the person is incapacitated or otherwise unable to speak, such communication capability is not beneficial.

Other situations may arise in various scenarios where notifying a party known to be a participant in an ad-hoc network can be useful. Previous designs to accomplish this task, such as in an enterprise environment, included devices wherein a central dispatching network was provided, typically for a fee, or a device such as a smartphone was used to notify a desired entity in the enterprise. Such solutions tend to be expensive.

It would be beneficial to provide an alert system that minimizes response time and enables appropriate persons to quickly address a person who has become incapacitated or otherwise has an issue of concern.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

According to one embodiment, there is provided a notification system comprising a first alert device configured to transmit and receive alerts conforming to a long range, low energy consumption point to point or mesh communication protocol and at least one additional alert device configured to transmit and receive alerts conforming to the long range, low energy consumption point to point or mesh communication protocol. The first alert device is configured to transmit a network creation ping using the long range, low energy consumption point to point or mesh communication protocol, the network creation ping receivable by at least one additional alert device approved to join a decentralized network of alert devices. At least one additional alert device approved to join the decentralized network of alert devices receiving the network creation ping is configured to pair with the first alert device thereby establishing the decentralized network of alert devices. The first alert device and each additional alert device in the decentralized network of alert devices is configured to transmit an alert directly to at least one other alert device in the decentralized network of alert devices using the long range, low energy consumption point to point or mesh communication protocol.

According to a further embodiment, there is provided a notification system comprising a first alert device configured to transmit and receive alerts conforming to a long range, low energy consumption point to point/mesh communication protocol and at least one additional alert device configured to transmit and receive alerts conforming to the long range, low energy consumption point to point/mesh communication protocol. The first alert device is configured to transmit a network creation ping using the long range, low energy consumption point to point/mesh communication protocol, the network creation ping receivable by at least one additional alert device approved to join a decentralized network of alert devices. At least one additional alert device approved to join the decentralized network of alert devices receiving the network creation ping is configured to pair with the first alert device thereby establishing a current decentralized network of alert devices. The first alert device is configured to transmit an alert directly to at least one other alert device in the current decentralized network of alert devices using the long range, low energy consumption point to point/mesh communication protocol.

According to another embodiment, there is provided a method for providing alerts comprising transmitting a network creation ping from a first device in a point to point decentralized network of alert devices using a long range, low energy consumption point to point/mesh communication protocol, the network creation ping receivable by at least a second alert device approved to join the point to point decentralized network of alert devices, pairing the second alert device receiving the network creation ping with the first alert device thereby establishing a current point to point decentralized network of alert devices, and transmitting and receiving alerts conforming to the long range, low energy consumption point to point/mesh communication protocol from the first device to a different device in the point to point decentralized network of alert devices.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 illustrates the operation of the overall system;

FIG. 2 represents components of the device;

FIG. 3 is a first portion of an operational flowchart of the functionality of the present design;

FIG. 4 is a second portion of the operational flowchart; and

FIG. 5 is a third portion of the operational flowchart.

### DETAILED DESCRIPTION

In this document, the words “embodiment,” “variant,” and similar expressions are used to refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

The present design provides a set of hardware that can be used to communicate with other hardware in an ad-hoc, malleable network arrangement wherein each device includes an ability to notify any or all other devices in the ad-hoc network. As a result, persons who have an emergency or a need to summon someone who is or may be a member of the ad-hoc network can receive rapid attention and have their issue addressed. The system may be used for other notification or alerting purposes for devices and users in the ad-hoc network.

The system also enables users to notify others in the network as desired and can be applied in a variety of situations. For example, an impromptu meeting called in one part of a building using the present system may enable persons to contact others in a defined group using the design provided.

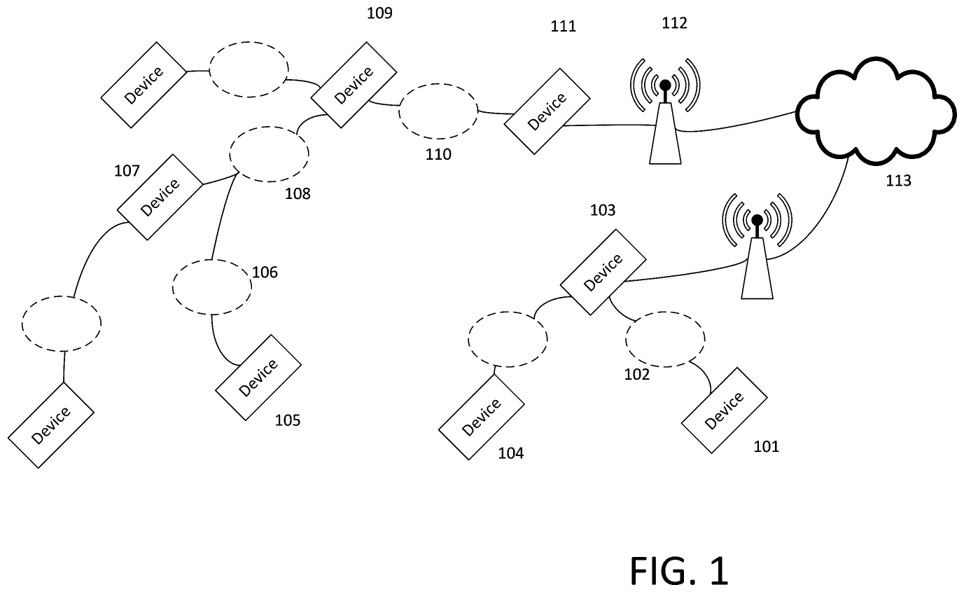

FIG. 1 is a general overview of the system. FIG. 1 includes a series of wristbands including device 101. In any arrangement similar to the conceptual representation of FIG. 1, while wristbands are depicted, any type of device having the functionality described herein may be employed. A simple device that goes in a pocket or can be worn around the neck may be provided, and thus the term “wristband” as used herein is not intended to be limiting, but an embodiment used to hold the device depicted and described in the system disclosed. The wristbands may communicate using any reasonable and acceptable communication protocol

One such protocol is LoRa. LoRa has an ability to provide long range communications with relatively low power requirements, but other communication protocols may be employed such as Wifi HaLo. Bluetooth, WiFi, or even cellular communication (4G, 5G, etc). LoRa, for example, can provide transmissions up to 10 kilometers, while Bluetooth is limited to distances such as 10 meters. Further, LoRa and LoRaWAN operates at ultra low power levels, while Bluetooth requires significantly higher power levels to operate. LoRa and LoRaWAN are point to point or mesh connection protocols. With respect to Wifi and particularly Wifi HaLow, LoRaWAN provides longer range communication with significantly less energy requirements by comparison. Thus in the present design, a transmission or communication channel such as LoRa is preferable, where LoRaWAN is better for those requiring long-range communication with minimal energy consumption. Wifi HaLow, for example, works for short or shorter ranges and transmits at a higher data rate than Wifi or LoRa, for example. For purposes of this disclosure, while any means, channels, or standards of communication can be employed. A long range, low energy consumption point to point or mesh communication protocol may be beneficially employed. Examples of such communication protocols include but are not limited to LoRa, LoRaWAN, EC-GSM, sigfox, MIOTY, and NB-IoT.

The system may cause the devices to transmit over a communication channel 102 between devices proximate one another depending on the communication protocol and channel employed. From FIG. 1, each of the devices is considered to be operating and connected to the network, but this may not always be the case. For example, device 107 may not be connected to the network, such as turned off or simply not authenticated or otherwise connected to the network. From FIG. 1, device 101 may transmit over communication channel 102 and may receive information, such as a notification, from device 104 over the same, or a similar, or even different communication channel. Such a notification is intended to be provided to any device in the vicinity, where vicinity is defined very loosely. For example, two devices may be part of the network but may be miles apart such that one device is simply out of range and cannot communicate with the other via any available acceptable communication path or protocol.

Devices in the network transmit beacon signals or other connection signals indicating they are at their current location and seeking to pair with like devices in the desired network. Authentication is provided such that only devices in the desired network are able to connect to the network. Form FIG. 1, device 101 may put out a beacon over communication channel 102 to device 103. Device 103 may not be part of the desired network, where the desired network may be established prior to transmission of the beacon or communication or may be established on an ongoing basis, such as person J is associated with device 103 and should become part of this specific network of devices including device 102. Device 103 may reject the invitation to join the network or device 103 may request, via appropriate communication, to join the network. As shown in FIG. 1, device 104 also connects via the communication channel with device 103.

Transmission sites, such as transmission towers, may be employed according to the current design. Tower 112 is shown and may include an Amazon Sidewalk Network or similar network element or arrangement such that the signal transmitted by devices in the vicinity, such as device 103, may be transmitted to remote locations via a network or the internet. Data processing may occur in the cloud shown here as cloud 113, wherein data processing may include determining a list of devices within the network, determining usage statistics, and so forth.

Tower 112 connects to various devices including device 105 which connects via communication channel 106 to the network. In this representation, device 107 can initiate an alert, such as by the user pressing a button on the device or the device sensing an event requiring transmission of a notification or alert, or the user typing such an indication into the device. The alert transmitted is shown as alert 108. Alert 108 can be received by device 109 which in turn can relay the message to other devices or the network for devices having connectivity to device 109. The alert may then propagate through the network to available and appropriate devices, such as being transmitted to tower 112 and back through device 103 to device 102 such that both device 102 and device 103 receive the alert. Alert transmission 110 is shown in this view, representing device 109 retransmitting the alert through the network.

Devices are thus able to communicate with other devices in the proximity, where the other devices may or may not be part of the network either in actuality or available for connection and contacted via beacon or transmission. In other words, device 107 may be unable to communicate directly with device 101, but device 107 may be sufficiently proximate device 109 and may be able to communicate with device 109. In FIG. 1, lines shown the direction of connectivity between devices, wherein in the representation presented device 105 and device 107 connect to device 109, and devices 101 and 104 connect to device 103. In this connectivity arrangement, device 105 can communicate through the network to devices not proximate thereto including device 101.

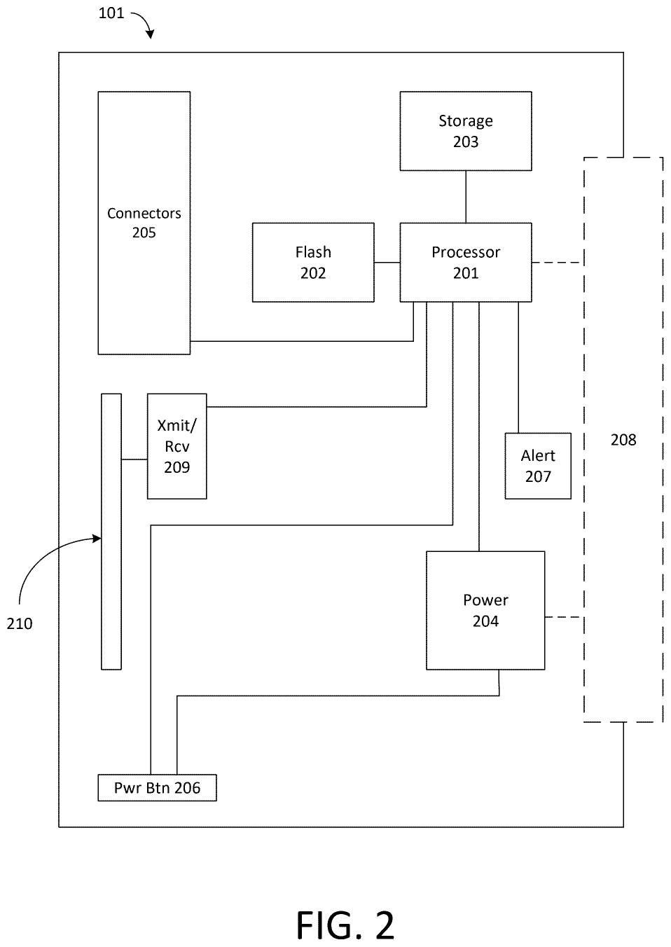

FIG. 2 illustrates a general overview of components employed in the current design. From FIG. 2, device 101 includes processor 201, flash memory 202, and storage memory 203, such as SRAM or PSRAM. Power is supplied by power source 204 which may be onboard or off, such as from a remote power source. Connectors 205 are provided which may connect to any external devices including but not limited to one or more external computing devices, displays, or other devices. Connections may be provided to, for example, USB connectors, ethernet connections, expansion components such as expansion boards, memory cards such as SD cards, other types of memory connectors, sensors, header connectors, power blocks, RCA connectors, FFC connectors, JST connectors, power connectors, DB9 connectors, and/or any other peripheral device reasonable under the circumstances to provide the desired functionality described herein.

Power button 206 may be provided wherein the unit may be turned on. Alert button 207 provides a means for the user to provide an alert manually to his or her network. Display 208 is provided and may be optional. Display 208 may be directly connected or integrally formed to device 101 or may be remote from device 101 and connected to device 101. In operation, the user may be provided with an ability to initiate a network, respond to an invitation to join a network, communicate with others in the network, find information about other devices in the network, and so forth. Such functionality benefits from availability of a display but such a display is not mandatory. If an alarm button on a device is instantiated by a user in an established network or an alert generated by any other available means, there may be tactile or audible functionality notifying the user of the alert. Such audio or tactile hardware is not shown in FIG. 2, and connections between the various components is also not presented. While certain connections between components are illustrated in FIG. 2, more, fewer, or different connections may be provided depending on placement of the components, needs for connection, and so forth.

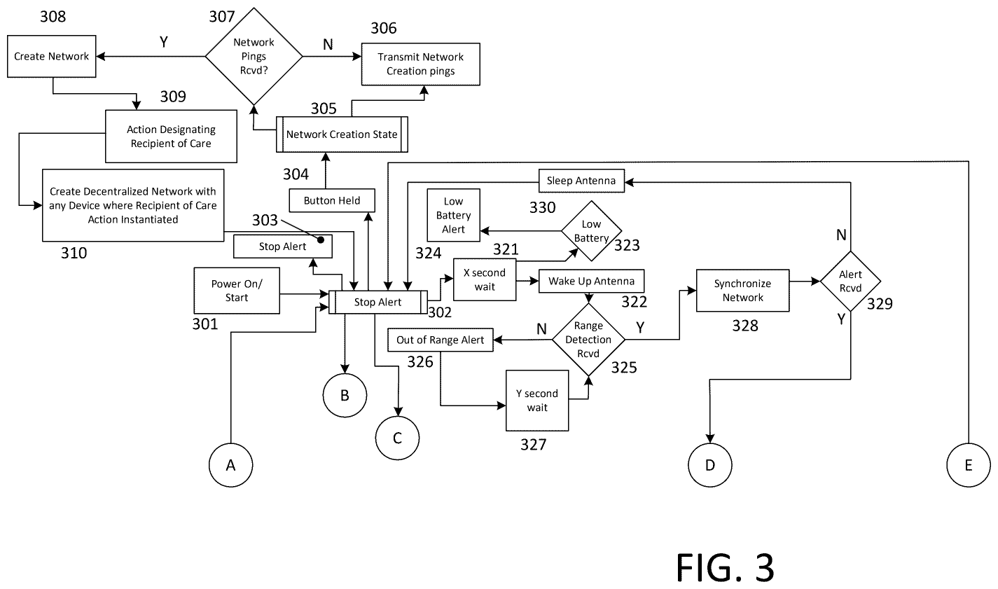

FIG. 3 illustrates a first part of a functional flowchart covering the operation of one embodiment of the current system. Point 301 calls for providing power to device 101. Device 101 goes into a ready state at point 302. Point 303 is a stop alert, indicating a stop event such as a system shutdown. From ready state 302, the system may proceed to point 304 which is a button press to create a network. Network creation state 305 can initiate pings or beacons by sending out such transmissions. Alternatively, the device may receive pings at point 306, where another device has sent out a beacon or ping to join the decentralized network.

In its simplest form, device 101 may attempt to contact a second device or receive a ping or beacon from a second device to establish a network. One or the other of the two devices may, as shown in point 306, send out the ping or beacon which may be received by the second device. In one implementation the second device may transmit information such as a paired indicator indicating the second device is joining the network. The first device may continue transmitting until the device times out or a connection is made and confirmation of connection received. Each device may have information about other devices or about the desired potential network participants. If a device receives a ping that is not in the network, and responds attempting to join the network but is not on the desired participant list, the device will not be connected to the network. Authentication and security is provided such that an undesired participant may not enter the network. As may be appreciated, multiple persons or devices may be allowed in a network and connection to one person or device does not foreclose opportunities to connect with others. Thus a device that connects with a second device may continue to transmit seeking other network participants, again for a predetermined period of time. The second device that connects with the first may also send out pings or beacons looking for other persons and devices in the network. Thus once a first device is connected to the second device and the decentralized network formed, the two devices may transmit beacons seeking additional network participants.

Thus the pings or beacons at point 306 represent pings or beacons sent by the device which may go on for a predetermined time irrespective of devices responding, while point 307 constitutes operation when the device is potentially receiving pings or beacons. Point 308 represents creation of the network by two or more devices. Once the network is created, point 309 waits for a button press to occur, which is optional. If a button press occurs or two or more appropriate devices link or pair to one another, the system proceeds to point 310 wherein the decentralized network is formed and each device is designated as a potential recipient of care or recipient of a care alert in this scenario. Upon formation of the decentralized network, the system returns to the ready state at point 302. Once the network is established, point 309 may be employed wherein the button is pushed or an indication otherwise provided indicating the device may be associated with one who needs care and/or a button push of the button or a different button, or other selection, may indicate the device is associated with one who may provide care.

In one embodiment, a low power transmission may be sent by one or more devices to verify devices remain in the decentralized network. If a device drops out of the network, for proximity reasons, or because the unit was turned off, or any other reason, the device may be noted to have been lost from the network and indications may be provided to network devices. Alternately, the devices may be initiated to again contact the device that dropped using the pings or beacons. The device that lost contact may not have communication with the network and may provide beacons or pings to locate other devices. Again, a time period may be provided for reconnecting with a device that drops from the network.

Alternately, from ready state 302, point 321 calls for a wait of a predetermined time before waking up the antenna at point 322. Additionally, point 323 calls for determining whether a low battery level exists, and if so, point 324 issues a low battery alert. Point 325 calls for receiving a range detection, i.e., another device being within range. If no range detection is received, and no other device is within range, point 326 issues an out of range alert, such as to the user indicating he or she is out of range, and point 327 is a predetermined time checking for range. Processing advances to point 325 and operation cycles until another device is in range. Point 328 synchronizes the network, such as by pairing, evaluating whether the other device is approved for the network and/or allowing the other device to join the network. Point 329 represents a check for an alert being received. If no alert is received, the antenna goes into sleep mode at point 330 and the system returns to ready state 302.

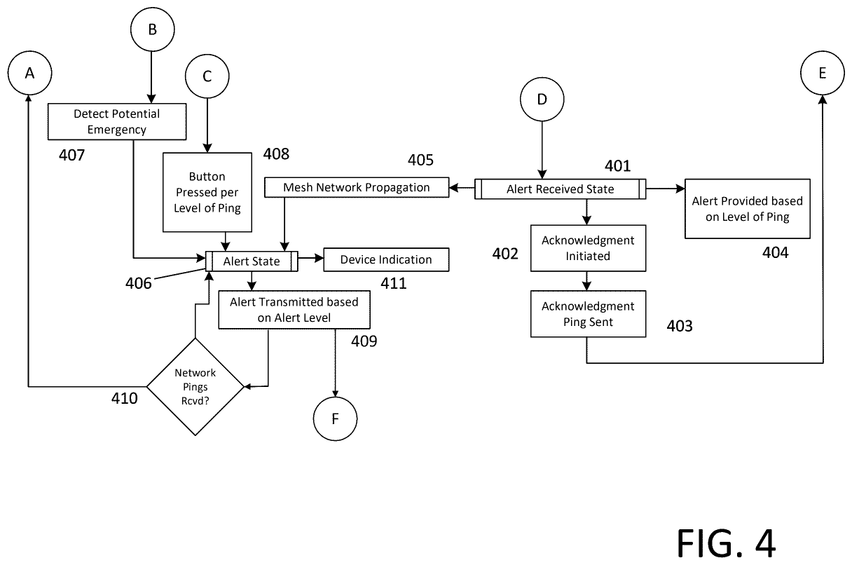

FIG. 4 illustrates further processing. From FIG. 4, while again in ready state 302, element 401 continues from element 329 to operate when an alert has been received. Element 401 represents the alert received state, wherein point 402 calls for the receiving device user to press the button on his or her device to acknowledge receipt of the alert. The receiver's device transmits an acknowledgement at point 403, such as a ping or beacon, to at least the transmitting device but also in many cases to other devices in the network. From point 403 the system transitions back to the ready state.

Point 404 provides an alert to the user when in the alert received state. Such an alert occurs in most cases prior to the button press and acknowledgement ping of points 402 and 403. After this, point 405 calls for the alert to be propagated over the decentralized network to available proximate devices. In FIG. 1, an alert transmitted by device 105 to device 109 propagates to, for example, device 110 via the communication channel employed by the devices in the decentralized network shown. From point 405, the system goes into an alert state at point 406, whereupon the device may vibrate or otherwise provide an audio or visual indication of the alert state at point 411.

Point 407 represents an alternate path from ready state 302. Point 407 detects a potential emergency from available conditions and circumstances, again such as receiving audio indications of a car crash, receiving information that the user has likely fallen, or otherwise. If so, point 407 transitions to alert state 406. Point 408 calls for pressing the button on the user's device, in one instance per each level of ping or beacon. Such a press per ping prevents the risk of false alarms, but other methods may be used, such as requiring multiple presses over a period of time. When in the alert state, each device may alert in any manner acceptable including by vibration, making a sound, or issuing a visual alert such as via display 208. Point 409 calls for sending out an alert ping or beacon depending on level of threat.

Threat level may be provided in various ways, including by the user, as determined by the device, according to a classification system or some other predetermined assessment function, or otherwise. As an example, classes of alerts may be provided, such as class 1 being mild and class 5 severe, with classes 2, 3, and 4 being intermediate but progressively more serious the larger the number. The user may press her button and the device may ask “threat level?” whereupon the user may enter the perceived threat level. Pings or beacons indicating “threat level 3” may be sent through the decentralized network. At point 410 the system provides acknowledgement of receipt of the ping or beacon and operation transitions to ready state 302 if the acknowledgement has been received but remains in alert state 406 if acknowledgement has not been received.

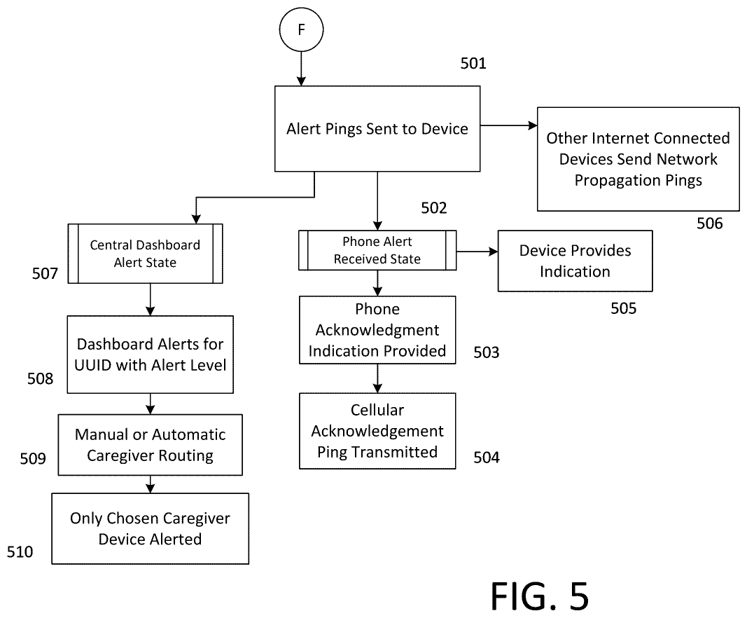

FIG. 5 illustrates further processing. Once the device has transmitted pings or beacons, in one embodiment based on level of alert, point 501 calls for the system transmitting alert pings or beacons to the internet and to any and all connected devices such as via the transmission arrangement provided in FIG. 1 including tower 112 and cloud 113. For an alert initiated by device 105 that has propagated to devices 109 and 110, this allows for transmission to, for example, device 103. Point 506 calls for devices that have received internet notification sending the propagation pings or beacons via the communication channel to other proximate devices, such as device 103 transmitting to device 101 over communication channel 102.

Point 502 indicates a device is in an alert received state. Point 503 calls for the user pressing the button on the device to indicate acknowledgement. In one embodiment, no button press is required, and the device simply provides acknowledgement without user action. At point 504, the internet or a cellular network may be employed to transmit the acknowledgement to other devices and to the device that transmitted the alert.

Point 507 provides a central dashboard alert. While the network is decentralized, alert notifications can be provided to entities previously identified, such as hospitals, police, fire, and so forth. In one embodiment, alerts can be provided for different types of emergencies, such as a fire, identification of a criminal, and so forth. Point 507 calls for a general alert state by which certain designated entities appropriate for the circumstances may be notified of the alert. The dashboard, which represents part of the alert system but is not shown in FIGS. 1-3, provides alerts to entities with appropriate credentials such as an appropriate UUID at point 508. Point 509 provides for either manual or automatic caregiver routing, while point 510 provides alerts only to selected caregivers.

While described herein with respect to emergency events such as a health event suffered by a user employing the design, the system and design is not limited to this use case. In an alternate embodiment, the system and devices may be used in a corporate or enterprise environment, providing for alerts and notifications to selected individuals having devices that communicate over a communication channel as disclosed. For example, the enterprise system may be used to notify desired users of an impromptu meeting, or hospital personnel may be notified of an emergency in Room 2385, or a spill event at a factory may be transmitted by one employee to a group of other employees. The system disclosed may be used in government, school, industrial, or any other appropriate venue where notifications or alerts among a small group may be beneficial. Such a system is less expensive and more targeted to a particular group and provides adequate notifications among group members for a variety of situations.

Thus according to one embodiment, there is provided a notification system comprising a first alert device configured to transmit and receive alerts conforming to a long range, low energy consumption point to point or mesh communication protocol and at least one additional alert device configured to transmit and receive alerts conforming to the long range, low energy consumption point to point or mesh communication protocol. The first alert device is configured to transmit a network creation ping using the long range, low energy consumption point to point or mesh communication protocol, the network creation ping receivable by at least one additional alert device approved to join a decentralized network of alert devices. At least one additional alert device approved to join the decentralized network of alert devices receiving the network creation ping is configured to pair with the first alert device thereby establishing the decentralized network of alert devices. The first alert device and each additional alert device in the decentralized network of alert devices is configured to transmit an alert directly to at least one other alert device in the decentralized network of alert devices using the long range, low energy consumption point to point or mesh communication protocol.

According to a further embodiment, there is provided a notification system comprising a first alert device configured to transmit and receive alerts conforming to a long range, low energy consumption point to point/mesh communication protocol and at least one additional alert device configured to transmit and receive alerts conforming to the long range, low energy consumption point to point/mesh communication protocol. The first alert device is configured to transmit a network creation ping using the long range, low energy consumption point to point/mesh communication protocol, the network creation ping receivable by at least one additional alert device approved to join a decentralized network of alert devices. At least one additional alert device approved to join the decentralized network of alert devices receiving the network creation ping is configured to pair with the first alert device thereby establishing a current decentralized network of alert devices. The first alert device is configured to transmit an alert directly to at least one other alert device in the current decentralized network of alert devices using the long range, low energy consumption point to point/mesh communication protocol.

According to another embodiment, there is provided a method for providing alerts comprising transmitting a network creation ping from a first device in a point to point decentralized network of alert devices using a long range, low energy consumption point to point/mesh communication protocol, the network creation ping receivable by at least a second alert device approved to join the point to point decentralized network of alert devices, pairing the second alert device receiving the network creation ping with the first alert device thereby establishing a current point to point decentralized network of alert devices, and transmitting and receiving alerts conforming to the long range, low energy consumption point to point/mesh communication protocol from the first device to a different device in the point to point decentralized network of alert devices.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A notification system comprising:
a first alert device configured to transmit and receive alerts conforming to a long range, low energy consumption point to point or mesh communication protocol; and
at least one additional alert device configured to transmit and receive alerts conforming to the long range, low energy consumption point to point or mesh communication protocol;
wherein the first alert device is configured to transmit a network creation ping using the long range, low energy consumption point to point or mesh communication protocol, the network creation ping receivable by at least one additional alert device approved to join a decentralized network of alert devices;
wherein at least one additional alert device approved to join the decentralized network of alert devices receiving the network creation ping is configured to pair with the first alert device thereby establishing the decentralized network of alert devices;
wherein the first alert device and each additional alert device in the decentralized network of alert devices is configured to transmit an alert directly to at least one other alert device in the decentralized network of alert devices using the long range, low energy consumption point to point or mesh communication protocol.

2. The notification system of claim 1, wherein upon one additional alert device in the decentralized network of alert devices receiving the alert, the one additional alert device subsequently transmits the alert over the decentralized network using the long range, low energy consumption point to point or mesh communication protocol.

3. The notification system of claim 1, wherein at least one of the first alert device and the at least one additional alert device is configured to transmit and receive data to hardware configured to forward alert information over the internet to a different alert device.

4. The notification system of claim 1, wherein the first alert device comprises a selectable button pressable to initiate the alert.

5. The notification system of claim 3, wherein one alert sent by the first alert device progressively propagates to all devices in the decentralized network.

6. The notification system of claim 1, wherein the first alert device is provided on a wearable apparatus.

7. The notification system of claim 1, wherein the alert comprises an enterprise related alert.

8. A notification system comprising:
a first alert device configured to transmit and receive alerts conforming to a long range, low energy consumption point to point/mesh communication protocol; and
at least one additional alert device configured to transmit and receive alerts conforming to the long range, low energy consumption point to point/mesh communication protocol;
wherein the first alert device is configured to transmit a network creation ping using the long range, low energy consumption point to point/mesh communication protocol, the network creation ping receivable by at least one additional alert device approved to join a decentralized network of alert devices;
wherein at least one additional alert device approved to join the decentralized network of alert devices receiving the network creation ping is configured to pair with the first alert device thereby establishing a current decentralized network of alert devices;
wherein the first alert device is configured to transmit an alert directly to at least one other alert device in the current decentralized network of alert devices using the long range, low energy consumption point to point/mesh communication protocol.

9. The notification system of claim 8, wherein upon one additional alert device in the current decentralized network of alert devices receiving the alert, the one additional alert device subsequently transmits the alert over the current decentralized network using the long range, low energy consumption point to point/mesh communication protocol.

10. The notification system of claim 8, wherein at least one additional alert device is configured to transmit and receive data to hardware configured to forward alert information over the internet to a different alert device.

11. The notification system of claim 8, wherein the first alert device comprises a selectable button pressable to initiate the alert.

12. The notification system of claim 10, wherein one alert sent by the first alert device progressively propagates to all devices in the decentralized network.

13. The notification system of claim 8, wherein the first alert device is provided on a wearable apparatus.

14. The notification system of claim 8, wherein the alert comprises one of a healthcare related alert and an enterprise related alert.

15. A method for providing alerts comprising:
transmitting a network creation ping from a first device in a point to point decentralized network of alert devices using a long range, low energy consumption point to point/mesh communication protocol, the network creation ping receivable by at least a second alert device approved to join the point to point decentralized network of alert devices;
pairing the second alert device receiving the network creation ping with the first alert device thereby establishing a current point to point decentralized network of alert devices; and
transmitting and receiving alerts conforming to the long range, low energy consumption point to point/mesh communication protocol from the first device to a different device in the point to point decentralized network of alert devices.

16. The method of claim 15, wherein upon one additional alert device in the current decentralized network of alert devices receiving the alert subsequently transmits the alert over the current decentralized network using the long range, low energy consumption point to point/mesh communication protocol.

17. The method of claim 15, wherein at least one additional alert device is configured to transmit and receive data to hardware configured to forward alert information over the internet to a different alert device.

18. The method of claim 15, wherein the first alert device comprises a selectable button pressable to initiate the alert.

19. The method of claim 15, wherein one alert sent by the first alert device progressively propagates to all devices in the decentralized network.

20. The method of claim 15, wherein the alert comprises one of a healthcare related alert and an enterprise related alert.
